(19) United States
(12) Patent Application Publication
(10) Pub. No.: US 2024/0067380 A1
(43) Pub. Date: Feb. 29, 2024

(54) METHOD AND SYSTEM FOR REMEDIATING FILLING VALVE AND PRESSURE DISTURBANCES IN A FOOD PACKAGING SYSTEM

(71) Applicant: Tetra Laval Holdings & Finance S.A., Pully (CH)

(72) Inventors: Gabriele Borelli, Spilamberto (MO) (IT); Federico Campo, Modena (IT)

(21) Appl. No.: 18/257,867

(22) PCT Filed: Dec. 17, 2021
(86) PCT No.: PCT/EP2021/086367

§ 371 Date: Jun. 15, 2023

Related U.S. Application Data
(60) Provisional application No. 63/126,858, filed on Dec. 17, 2020.

(51) Int. Cl. B65B 57/14; B65B 3/26; B65B 9/20; B65B 37/00; B65B 43/08; G05B 13/02

(52) U.S. Cl. CPC B65B 57/145; B65B 3/26; B65B 9/20; B65B 37/00; B65B 43/08; G05B 13/024; G05B 13/027

(57) ABSTRACT

Methods and apparatus, including computer program products, are described for filling packages (112) in a food packaging machine (100) with a food product, wherein the food packaging machine (100) comprises a plurality of sub-systems. One or more local variable values (116) are received, which indicate measurements by the food packaging machine (100) of one or more physical parameters for a local filling sub-system (300). One or more remote variable values (204) are received, which indicate measurements by the food packaging machine (100) of one or more physical parameters for one or remote sub-systems. One or more control parameter values are determined for the local filling sub-system (300) of the food packaging machine (100), by processing the remote (204) and local (116) variable values using a reinforcement learning model (206) and a local control model (210). One or more control parameters of the local filling sub-system (300) are adjusted in accordance with the determined control parameter values. The filling of packages (112) with food product by the food packaging machine (100) is controlled in accordance with the adjusted one or more control parameters.

### TECHNICAL FIELD

The invention relates to food packaging systems, and more specifically to remediating filling valve and pressure disturbances that may occur in a food packaging system.

### BACKGROUND

Automation control systems are used in a wide range of manufacturing and processing settings today and have continuously grown in complexity. A common approach for managing this complexity is to divide the system into sub-systems and develop suitable control mechanisms for each sub-system. However, this approach does not always result in an optimal solution for the system as a whole.

Capturing influencing factors from different sources becomes increasingly difficult as a system gets more complex and the number of influencing factors grows. This complexity further increases when the relationships between influencing factors, control variables and the system itself are non-linear and/or difficult to model.

With regards to the level of abstraction in industrial control, two main perspectives can be taken: low level control and high level control, respectively. Low level control implies the management of individual automation components (e.g., actuators, servo motors, heaters and many other devices). High level control can grow in abstraction going from a sub-system level, to a system level, and further to the orchestration of an entire plant with multiple systems and sub-systems that need to operate in concert.

As an example, food processing and packaging equipment typically includes several sub-systems, such as a filling system, a sterilizing system, a package folding system, etc. Each sub-system contains a number of different elements (e.g., pneumatic actuators, servo motors, DC motors, AC motors, sensors, other actuators, etc.). These individual elements are typically controlled by a low level, local control system that exploits conventional control techniques, such as Proportional Integral Derivative (PID) controllers, to control a target variable. A feedback loop is used to keep the error of the controller low with respect to a target working point of the element, system, or sub-system.

However, PID controllers need to be tuned for their specific application and are usually optimized for a specific working range and working dynamics. They are also not very well suited to adapt to unforeseen circumstances or working conditions that are outside of their conventional working zone. When such conditions change (e.g., different working environment, changes in the automation element, changes in the manufacturing process, etc.) the parameters of the PID controller often need to be tuned and re-calibrated. This can be a time-consuming and complex process that requires significant manual input from experienced personnel, especially when a large number of elements and/or sub-systems are involved, such as is typically the case in food processing and packaging equipment.

A filling machine is an example of a complex system that packages liquid, semi-liquid or pourable food products, such as fruit juice, UHT (ultra-high temperature treated) milk, wine, tomato sauce, etc., into composite packages made of a multilayer composite packaging material for distribution and sale. A typical example is the parallelepiped-shaped package for pourable food products known as Tetra Brik Aseptic™, which is made by sealing and folding a laminated strip packaging material. The packaging material has a multilayer structure comprising a carton and/or paper base layer, covered on both sides with layers of heat-seal plastic material, e.g. polyethylene. In the case of aseptic packages for long-storage products, the packaging material also includes a layer of oxygen-barrier material, e.g. an aluminum foil, which is superimposed on a layer of heat-seal plastic material, and is in turn covered with another layer of heat-seal plastic material forming the inner face of the package eventually contacting the food product.

The filling machine starts from a web of multilayer composite packaging material (wound from a reel). The web is fed through the filling machine, wherein a tube is formed from the web by producing a longitudinal sealing. A specified amount of the food product is fed into the tube via a pipe; a lower end of the tube is then fed into a folding device, in which a transversal sealing is produced, the tube being folded according to folding lines, also referred to as weakening lines, and then cut off such that the composite packages filled of the liquid food product are formed.

The amount of food product that is delivered to the tube that is subsequently cut into single packages is regulated by a filling valve. The filling valve might be susceptible to events and working condition changes when the valve is controlled with conventional control techniques, such as a PID controller. Further, the pressure of the food product in the line that leads up to the filling valve (also referred to herein as “product pressure”) is an unmeasured noise factor that can negatively affect the performance of the control of filling valve. A PID controller for the filling valve might be slow in reacting to pressure changes and as a result, filling issues (e.g. overfilling) may occur. In addition, the PID gains often need to be manually tuned by a technician for every volume of the expected packages and every type of food product to be filled into the packages.

Thus, there is a need for improved techniques for controlling the filling valve and to remediate pressure disturbances, which also take into account a range of events that occur in the packaging machine or sometimes even outside the packing machine itself.

### SUMMARY

It is an object of the invention to at least partly overcome one or more limitations of the prior art. In particular, it is an object to provide methods and systems that make it possible to improve the control a filling valve of a food packaging machine in response to various events that occur inside or outside the filling machine by taking into account measured parameter values not only for a local filling valve sub-system, but also for other, remote, sub-systems in the food packaging machine, or even outside the food packaging machine. As a result, proper filling of packages (i.e., just the correct amount and no over- nor underfilling) can be accomplished, which enables both a quicker setup process when the food packaging machine is first installed, and better handling of unexpected events, ultimately resulting in fewer packages needing to be discarded.

In one aspect of the invention, this is achieved by a method for filling packages in a food packaging machine with a food product, wherein the food packaging machine comprises a plurality of sub-systems. The method includes:
receiving one or more local variable values indicating measurements by the food packaging machine of one or more physical parameters for a local filling sub-system;
receiving one or more remote variable values indicating measurements by the food packaging machine of one or more physical parameters for one or remote sub-systems;
determining one or more control parameter values for the local filling sub-system of the food packaging machine, by processing the remote variable values and the local variable values using a reinforcement learning model and a local control model;
adjusting one or more control parameters of the local filling sub-system in accordance with the determined control parameter values; and
controlling the filling of packages with food product by the food packaging machine in accordance with the adjusted one or more control parameters.

The exploitation of both local variables and inputs from remote sub-systems will results in more precisely controlled filling valve and a more resilient operation when unexpected pressure changes occur in the line that contains the food product to be filled into the packages. This results in fewer wasted packages (and food product), and thus more efficient and environmentally friendly operation of the food packaging machine. Given the ability to better control the package forming process, shorter time to market for new products and/or configurations is also made possible as less manual testing is needed. This is further enhanced as control policies can be learned in simulated environment, such that the food packaging machine does not need to be manually configured “from scratch”.

In one embodiment, the reinforcement learning model is a deep reinforcement learning model including a neural network. Deep reinforcement learning is particularly useful when evolving control policies for sub-systems that must consider a large number of variables whose internal relations and effects on the sub-system may not be known, and presents a more sophisticated approach to determining the one or more control parameter values for the local filling sub-system of the food packaging machine than what might be possible using conventional reinforcement learning without a neural network.

In one embodiment, the method includes receiving one or more remote variable values indicating measurements of one or more physical parameters for one or systems that are external to the packaging machine. This enables the packaging machine to take into accounts events that may occur without the packaging machine itself, when determining and adjusting the control parameters to fill the packages.

In one embodiment, the local filling sub-system is connected by a line to a central repository containing the food product and is configured to dispense a specific amount of the food product into each package, and a remote variable value represents a pressure of the food product in the line. This allows several packaging machines to connect to the same central repository with food product, and allows the filling sub-system of each machine to respond to pressure changes that may occur in their own line due to events that occur in, or are otherwise related to, the other packaging machines.

In one embodiment, adjusting one or more control parameters of the filling sub-system includes adjusting one or more of: a timing of opening a filling valve through which the food product passes when being added to a package, and a degree to which the filling valve is opened when dispensing food product into the packages. That is, by more precisely controlling how long and to what degree a filling valve is open, based on the information received from various sub-systems and external systems, it is possible to the amount of food product that is filled into each package.

In one embodiment, the neural network is a convolution neural network, a recurrent neural network, a Long Short-Term Memory neural network, or a fully connected neural network. These are all different categories of networks that are well known to those having ordinary skill in the art and are thus more easily incorporated into existing food packaging machine settings.

In one embodiment, the one or more local variable values include filling valve dynamics reflecting transients in opening and closing of the filling valve, and a filling valve control signal reflecting a degree of openness of the filling valve; and the one or more remote variables include: product type, number of lines connected to a central product repository, working status of the lines connected to the central product repository, and a pressure variation of the food product at the input of the filling sub-system. These are all common parameters that are measured in most conventional packaging and production systems. Using these parameters to better control the local filling sub-system, as is accomplished by the data-driven approach of the various embodiments described herein, significantly enhances the operation of the filling sub-system, and thus the overall operation of the packaging machine.

Other aspects of the invention include a system and a computer program for filling packages in a food packaging machine with a food product. The features and advantages of these aspects of the invention are substantively the same as those discussed above for the method.

Still other objectives, features, aspects and advantages of the invention will appear from the following detailed description as well as from the drawings.

### DRAWINGS

Embodiments of the invention will now be described, by way of example, with reference to the accompanying schematic drawings.

FIG. 1 is a schematic diagram of a portion of a food packaging machine, in accordance with one embodiment.

FIG. 2 is a schematic diagram of a controller in a food packaging machine, in accordance with one embodiment.

FIG. 3 shows a schematic diagram of a filling sub-system, in accordance with one embodiment of the invention.

### DETAILED DESCRIPTION

As was mentioned above, a goal with the various embodiments of the invention is to provide improved control techniques for equipment and systems relating to food processing and packaging, and in particular with respect to filling packages with a food product. Filling packages with the correct amount of food product is important, not only from a “customer expectation” point of view, but also from a functionality point of view, as over- or underfilling packages may result in significant downtime for the packing machine while the problem is corrected, as well as in wasted packages, which is undesirable from a food waste and an environmental point of view. By applying the general concepts of reinforcement learning and/or deep reinforcement learning techniques to control a filling system of the food packaging machine, a larger range of factors can be taken into account compared to what is possible in existing systems and the filling of the food product can be adjusted very precisely, such that over- or underfilling can be avoided and the food packaging machine can be used more efficiently with fewer discarded food packages.

Both reinforcement learning and deep reinforcement learning are examples of machine learning techniques. In general, reinforcement learning (RL) can be characterized as dynamically learning through the use of positive or negative rewards. A system performance is evaluated with respect to a desired target. If the target is reached or not, a positive reward is delivered, and if the target is not reached, a negative reward is delivered. As the positive and negative rewards accumulate over time, the RL model evolves a control policy for the system, with the goal of maximizing the outcome. Deep reinforcement learning (DRL) can be characterized as an enhancement of RL, in which RL is used together with a neural network when evolving the control policy for the system.

In the context of food processing and packaging, RL (i.e., agent-environment interaction) can be used to evolve a control policy for a food processing and/or packaging machine. Using DRL (i.e., RL together with a neural network) can be particularly useful when evolving control policies for sub-systems, such as the filling sub-system, that must consider a large number of variables whose internal relations and effects on the sub-system may not be known. In addition, it should be noted that RL and DRL techniques can also be used to improve existing, local control techniques, in essence by “filling in the gaps” of conventional control techniques with this data-driven approach. Thus, the DRL algorithm can then directly (or indirectly through other control layers, e.g., by tuning the gains of a conventional PID controller to allow the PID controller to operate more efficiently compared to the conventional control techniques) control the actuators (e.g., servomotors, pneumatic actuators or other actuators) that remediate filling valve and pressure disturbances that may occur in a food packaging system.

In order to further illustrate these principles, various embodiments of the invention will now be described more fully by way of example of controlling a filling sub-system in a food packaging machine, and with reference to the accompanying drawings in which some, but not all, embodiments of the invention are shown. The invention may be embodied in many different forms and should not be construed as limited to the embodiments set forth herein. For example, while various embodiments of the invention will be described with reference to a roll-fed carton packaging machine, other embodiments of the invention can be applied in situations where discrete packages have already been formed, and which may have any shape or form or be made of any material, such as, PET bottles, glass bottles or cans made of metal, just to mention a couple of examples. While such containers may have been formed using other processes than the one described below, or by other machines, or even in other production facilities, the same general principles apply for filling food product into these containers, and thus the same control methods for the filling sub-systems of machines designed to fill these different types of containers can also be applied in these settings.

As was mentioned above, a filling sub-system is an important part of a food packaging machine, and its operation needs to be carefully controlled in order to ensure that the correct amount of food product is filled into the packages and that no over- or underfilling occurs.

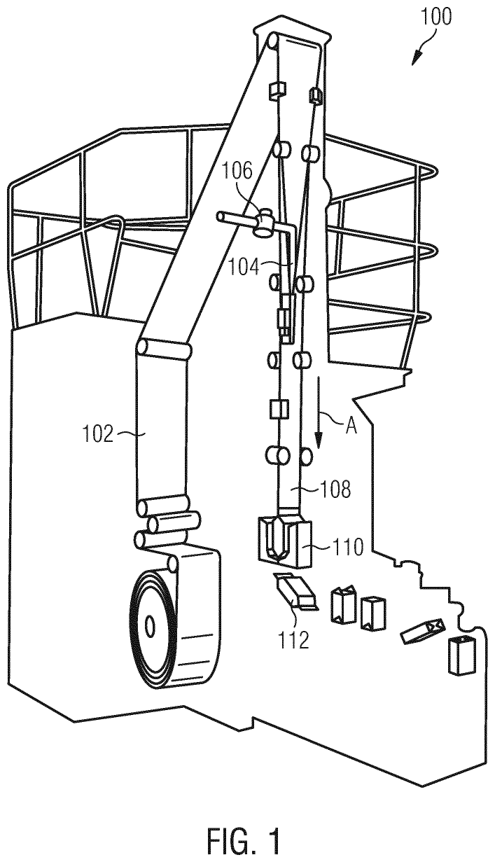

FIG. 1 generally illustrates a food packaging machine 100. In the illustrated example, the food packaging machine 100 is a roll-fed carton packaging machine. The general 20 principle of such a machine is that from a roll of packaging material a web 102 is formed. The food packaging machine 100 may comprise a roll receiver (not illustrated in the figure) for receiving the roll of packaging material. Although not illustrated, if needed in order to fulfill food safety regulations, the web 102 may be sterilized using a hydrogen peroxide bath, a Low Voltage Electron Beam (LVEB) device or any other apparatus capable of reducing a number of unwanted microorganisms.

After sterilization, by using a tube former, the web 102 can be formed into a tube 104. According to one non-limiting example, the tube former may be a longitudinal sealing device. When having formed the tube a food product, for instance milk, can be fed into the tube 104 from a product filling device via a product pipe 106 placed at least partly inside the tube 104. A food product in this context refers to anything that people or animals ingest, eat and/or drink or that plants absorb, including but not limited to liquid, semi-liquid, viscous, dry, powder and solid food products, drink products, and water. For the avoidance of doubt, food products also include ingredients for preparing food. Some examples of food products include milk, water and juice.

In order to form a package 112 from the tube 104 filled with product, a transversal sealing can be made in a lower end of the tube by using a sealing sub-system 110, also often referred to as a “jaw system.” Generally, the sealing sub-system 110 has two main functions—providing the transversal sealing, i.e., welding two opposite sides of the tube 104 together such that the product in a lower part of the tube 104, placed downward the sealing sub-system 110, is separated from the product in the tube 104 placed upward the sealing sub-system 110, and cutting off the lower part of the tube 104 such that the package 112 is formed. Alternatively, instead of providing the transversal sealing and cutting off the lower part in one and the same apparatus as illustrated, the step of cutting off the lower part may be made in a subsequent step by a different piece of equipment, or by the consumer if the packages are intended to be sold in a multi-pack.

In addition, the controller also receives input from one or more remote sub-systems of the food packaging machine 100, and from one or more remote systems outside of the food packaging machine 100, which all may experience events that also influence the operation of the filling sub-system. For example, a production plant may include several packaging machines 100, each of which may be connected by a line to a central food product repository 301, such as a tank containing a liquid to be filled into individual packages 112 by the packaging machines 100. If one of the packaging machines 100 experiences a problem, this may cause the pressure in the lines to the other packaging machines 100 to change. The filling sub-systems of these other packaging machines 100 need to react to such a change in order to avoid over- or underfilling of the respective packages 112. Similarly, the density and/or viscosity of a product may have an impact on the behavior of a filling valve of the packaging machine. For example, a filling valve may need to open more or stay open for a longer time when filling a package 112 with a viscous or semi-solid liquid (e.g., beans or crushed tomatoes) compared to a smooth liquid (e.g., water or apple juice). In yet another example, the filling of the packages 112 may be affected by the ambient temperature in the production plant (e.g., some liquids flow more smoothly at higher temperatures), or by the physical configuration of the production plant (e.g., whether the tank containing the food product is located on a lower or higher level than the packaging machine so that gravity is an issue to take into account). As the skilled person realizes there is a very large number of local and remote factors that potentially could have an effect on the filling of food product into the packages 112 and which need to be taken into consideration in order to achieve improved control of the filling sub-system. There can also be several food product repositories 301 connected to the packages machine 100.

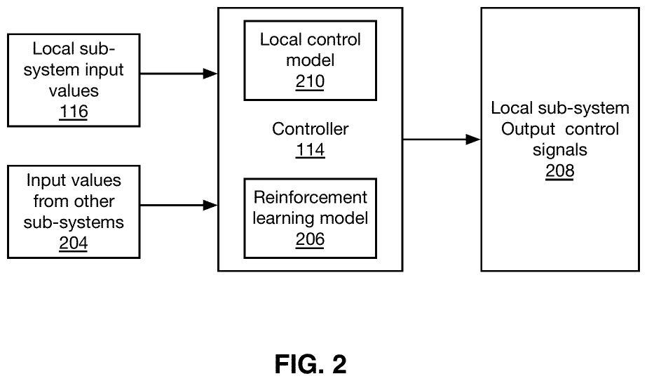

These events and external factors can be represented by a set of variables, whose values indicate various states at different sub-systems of the food packaging machine 100, or states of various systems that are external to the food packaging machine 100. This is schematically illustrated in FIG. 2, which shows how the input variable(s) 116 from the local sensor(s) of the filling sub-system is input to the controller 114 along with the input values 204 from other sub-systems of the food packaging machine.

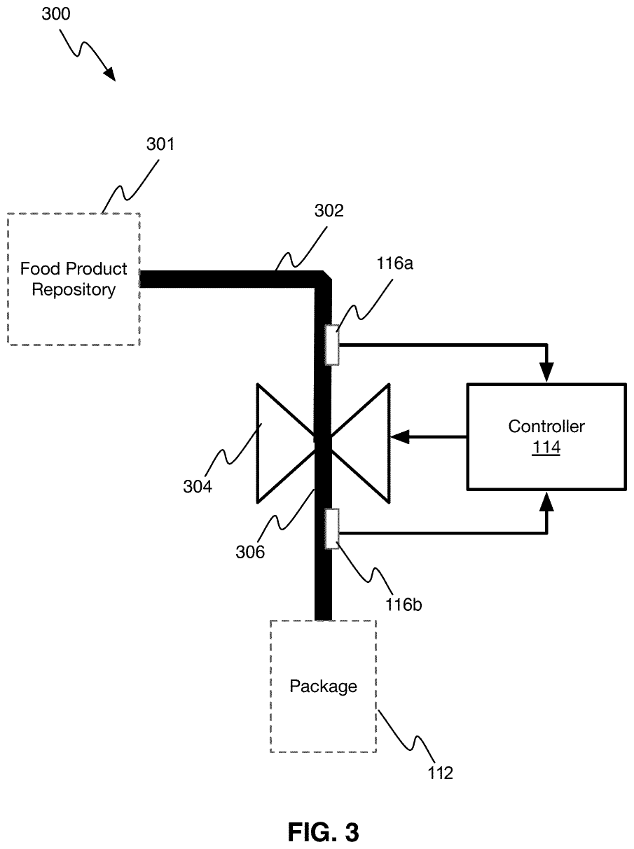

FIG. 3 shows a schematic view of a filling sub-system 300 in accordance with one embodiment of the invention. As can be seen in FIG. 3, a line 302 is connected to a food product repository 301, from which food product is to be transferred through the line into a container (which may be a tube formed by the web, or a discrete container). As mentioned, a filling valve 304 can open to various degrees and for certain time periods to dispense a certain amount of food product through line 306 into the container. The filling valve 304 is controlled by the controller 114. In the embodiment of the filling sub-system 300 shown in FIG. 3, there are two sensors 116a and 116b. The first sensor 116a is disposed in the line 302 before the valve 304 and measures the pressure in the line 302. The second sensor 116b measures the amount of food product that is transferred to the food package 112, for example, by measuring a level of the food product, it should be noted that these are merely two examples of process variables that can be measured by the sensors 116a and 116b, and that in other embodiments, other parameters can be measured, based on the specific configuration at hand. Collectively, the measured values by sensors 116a and 116b will be referred to below as local filling sub-system input variables 116.

In one embodiment, some examples of variables representing physical parameters from the local filling sub-system include:
filling valve dynamics reflecting transients in opening and closing of the filling valve (i.e., the brief pressure drop or pressure increase that occurs when opening or closing the valve, and rapidly stabilizes again), and
a filling valve control signal reflecting a degree of openness of the filling valve.

In one embodiment, some examples of variables from other sub-systems of the packaging machine, or from external systems outside the packaging machine, include:
food product type (and/or viscosity for the product),
number of lines connected to a central food product repository 301 (e.g., a larger number of lines generally results in a greater number of events and may affect how the filling valve is controlled compared to when there is only a smaller number of lines, and thus fewer events),
working status of the lines connected to the central food product repository 301 (e.g., the line to each filling machine can be operated in a particular status, such as preparation, production, cleaning, stop, or have a food product moving through the line at different speeds, depending on what the food packaging machine 100 is doing at any given time), and
a pressure variation of the food product at the input of the filling sub-system.

As can be realized, these are merely a few examples of possible influencing factors from other sub-systems or external systems, and should not be considered as an exhaustive list. However, they do represent influencing factors which cannot be considered by conventional filling valve control systems, as it is difficult or impossible to determine how various possible combination of these factors should influence the operation of the filling valve sub-system.

In accordance with the various embodiments described herein, the controller 114 uses a local control model 210 to process the local filling sub-system input variables 116, in combination with a reinforcement learning model 206 to process the input values from the other sub-systems as well as any input variables for external systems, to determine how all the measured variables as a whole collectively influence the operation of the filling sub-system. The local control model 210 can be an algorithm executed by a PID controller. The reinforcement learning model 206 can be a deep reinforcement learning model, which includes one or more neural networks, as described above. In some embodiments, the local sub-system input variables 116 can be processed by the reinforcement learning model 206. In some embodiments, the reinforcement learning model 206 can be used to figure out how different combinations of local and remote variables should influence the filling sub-system and use this insight to improve the local control model 210. Based on the result of this processing and determination, the controller 114 generates a set of output control signals 208 for the local filling sub-system, which control filling valve such that the correct amount of food product is filled into the packages 112. Typically, for a filling valve, the parameters that are controlled include one parameter specifying to what degree the filling valve should open (e.g., 0% for fully closed, to 100% for fully open) and a time specifying how long the filling valve should be kept open at the desired degree. However, this will of course vary depending on the particular type of filling valve that is used, and is a matter of design choice for the systems engineer.

Examples of neural networks that can be used in embodiments that use a deep reinforcement learning model include, for example, a Convolution Neural Network (CNN) that has been trained using reinforcement learning and deep reinforcement learning, a Recurrent Neural Network (RNN), such as a Long Short-Term Memory (LSTM) neural network, which is often used in the field of deep learning, or a Fully Connected Neural Network. The LSTM network may be particularly useful since, unlike standard feedforward neural networks, the LSTM has feedback connections. This enables the LSTM to process not only single data points, but also entire sequences of data, which can be particularly useful in the context of a food packaging machine designed to generate a large number of packages 112.

Conventional control techniques often require a manual calibration for each different working setup, e.g., package size, food product type, etc., which can often be a very time-consuming process. In contrast, this embodiment of the invention allows for a training environment to be provided, in which simulations can be made for how different parameters vary, which enables the controller 114 to learn the optimal control policy given the goal for the filling sub-system. This may save a considerable number of manhours in setting up the packaging machine, and thereby also reduce the time to market of new packages and products. In some embodiments, the output from the reinforcement learning model can be used to tune the gains of a conventional PID controller, such that the PID controller can operate more efficiently compared to the conventional control techniques where it relies only on local variable values.

It should be noted that even though a sub-system has been referred to above as a filling system, a sterilizing system, a package folding system, etc. it can also refer to a portion of the above-mentioned sub-system, or individual elements.

It should be noted that in some embodiments, the control models for the controller 140 can reside within the controller 140 itself, as illustrated in FIG. 2. In other embodiments, they may reside in and operate from external hardware/software (e.g., an external computer or similar processing equipment) to further accelerate the required computations and the controller 140 in the food packaging machine may be a simpler controller that merely executes the functionality, as determined by the external hardware/software.

The systems and methods disclosed herein can be implemented as software, firmware, hardware or a combination thereof. In a hardware implementation, the division of tasks between functional units or components referred to in the above description does not necessarily correspond to the division into physical units; on the contrary, one physical component can perform multiple functionalities, and one task may be carried out by several physical components in collaboration.

Certain components or all components may be implemented as software executed by a digital signal processor or microprocessor, or be implemented as hardware or as an application-specific integrated circuit. Such software may be distributed on computer readable media, which may comprise computer storage media (or non-transitory media) and communication media (or transitory media). As is well known to a person skilled in the art, the term computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, optical or magnetic storage devices, or any other medium which can be used to store the desired information, and which can be accessed by a computer.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

From the description above follows that, although various embodiments of the invention have been described and shown, the invention is not restricted thereto, but may also be embodied in other ways within the scope of the subject-matter defined in the following claims.

1. A method for filling packages in a food packaging machine with a food product, the method comprising:
receiving one or more local variable values indicating measurements by the food packaging machine of one or more physical parameters for a local filling sub-system of a plurality of local sub-systems;
receiving one or more remote variable values indicating measurements by the food packaging machine of one or more physical parameters for one or more remote sub-systems;
determining one or more control parameter values for the local filling sub-system, by processing the remote variable values and the local variable values using a reinforcement learning model and a local control model;
adjusting the one or more control parameters of the local filling sub-system in accordance with the determined control parameter values; and
controlling a filling of the filling packages with the food product by the food packaging machine in accordance with the adjusted one or more control parameters.

2. The method according to claim 1, wherein the reinforcement learning model comprises a deep reinforcement learning model including a neural network.

3. The method according to claim 1, further comprising:
receiving one or more remote variable values indicating measurements of one or more physical parameters for one or more systems that are external to the food packaging machine.

4. The method according to claim 3, wherein the local filling sub-system is connected by a line to a central repository containing the food product and is configured to dispense a specific amount of the food product into each of the filling packages and a remote variable value represents a pressure of the food product in the line.

5. The method according to claim 1, wherein adjusting one or more control parameters of the filling sub-system includes adjusting one or more of: a timing of opening a filling valve through which the food product passes when being added to the filling package, or a degree to which the filling valve is opened when dispensing the food product into the filling packages.

6. The method according to claim 2, wherein the neural network comprises one of: a convolution neural network, a recurrent neural network, a Long Short-Term Memory neural network, or a fully connected neural network.

7. The method according to claim 1, wherein:
the one or more local variables include: filling valve dynamics reflecting transients in opening and closing of the filling valve, or a filling valve control signal reflecting a degree of openness of the filling valve; and
the one or more remote variables include: food product type, number of lines connected to a central food product repository, working status of the lines connected to the central food product repository, or a pressure variation of the food product at an input of the filling sub-system.

8. A food packaging machine comprising:
a plurality of local sub-systems configured for filling packages with a food product;
a memory; and
a processor,
wherein the memory stores instructions that, when executed by the processor, cause the processor to perform a method comprising:
receiving one or more local variable values indicating measurements by the food packaging machine of one or more physical parameters for a local filling sub-system of the plurality of local sub-systems;
receiving one or more remote variable values indicating measurements by the food packaging machine of one or more physical parameters for one or remote sub-systems;
determining one or more control parameter values for the local filling sub-system, by processing the remote variable values and the local variable values using a reinforcement learning model and a local control model;
adjusting one or more control parameters of the local filling sub-system in accordance with the determined control parameter values; and
controlling a filling of the filling packages with the food product by the food packaging machine in accordance with the adjusted one or more control parameters.

9. The food packaging machine according claim 7, wherein the reinforcement learning model comprises a deep reinforcement learning model including a neural network.

10. The food packaging machine according to claim 8, wherein the method performed by the processor further comprises:
receiving one or more remote variable values indicating measurements of one or more physical parameters for one or more systems that are external to the food packaging machine.

11. The food packaging machine according to claim 10, wherein the local filling sub-system is connected by a line to a central repository containing the food product and is configured to dispense a specific amount of the food product into each of the filling packages, and a remote variable value represents a pressure of the food product in the line.

12. The food packaging machine of according to claim 8, wherein adjusting one or more control parameters of the filling sub-system includes adjusting one or more of: a timing of opening a filling valve through which the food product passes when being added to the filling package, or a degree to which the filling valve is opened when dispensing the food product into the filling packages.

13. The food packaging machine according to claim 9, wherein the neural network comprises one of: a convolution neural network, a recurrent neural network, a Long Short-Term Memory neural network, of a fully connected neural network.

14. The food packaging machine according to claim 8, wherein:
the one or more local variables include: filling valve dynamics reflecting transients in opening and closing of the filling valve, or a filling valve control signal reflecting a degree of openness of the filling valve; and
the one or more remote variables include: food product type, number of lines connected to a central food product repository, working status of the lines connected to the central food product repository, or a pressure variation of the food product at an input of the filling sub-system.

15. A computer program product comprising a non-transitory computer readable storage medium with instructions that, when executed to a processor, cause the processor to carry out the method according to claim 1.
